(19) United States
(12) Patent Application Publication
(10) Pub. No.: US 2014/0321790 A1
(43) Pub. Date: Oct. 30, 2014

(54) ELECTRO-OPTICAL MODULATOR HAVING HIGH EXTINCTION RATIO WHEN FUNCTIONING AS SWITCH

(71) Applicant: HON HAI PRECISION INDUSTRY CO., LTD., New Taipei (TW)

(72) Inventor: HSIN-SHUN HUANG, New Taipei (TW)

(73) Assignee: HON HAI PRECISION INDUSTRY CO., LTD., New Taipei (TW)

(21) Appl. No.: 13/945,914

(22) Filed: Jul. 19, 2013

(30) Foreign Application Priority Data
Apr. 30, 2013 (TW) 102115352

(51) Int. Cl. G02F 1/225

(52) U.S. Cl. CPC G02F 1/2257
USPC 385/3

(57) ABSTRACT

An electro-optic modulator includes a substrate, an end-to-end Y-shaped waveguide for optical divergence and convergence, and electrodes. The waveguide is formed in the substrate and the electrodes are formed in the substrate and received voltages act to modulate first and second sections of the waveguide such that the optical output by the first and second sections are equal or opposite to each other in all necessary respects regarding phase and amplitude.

### BACKGROUND

1. Technical Field

The present disclosure relates to integrated optics and, particularly, to an electro-optic modulator having a high extinction ratio when functioning as a switch.

2. Description of Related Art

Electro-optic modulators, such as Mach-Zehner electro-optic modulators, change a refractive index of a branch of a Y-shaped waveguide (hereinafter the first branch) using a modulating electric field, utilizing electro-optic effect. Thus, the modulator can alter a phase of lightwaves traversing the first branch. As a result, the lightwaves traversing the first branch have a phase shift and thus interfere with lightwaves traversing another branch of the Y-shaped waveguide (hereinafter the second branch). An output of the Y-shaped waveguide is modulated as the output depends on the phase shift, which in turn depends on the modulating electric field. However, being limited by manufacturing imprecision, all the properties of the lightwaves traversing the first and second branches are not the same. As such, when the modulator is used as a switch, the output is often larger than zero in an off state (i.e., the phase shift is π) or less than a desired maximum value in an on state (i.e., the phase shift is zero). An extinction ratio of the switch is thus less than satisfactory.

Therefore, it is desirable to provide an electro-optic modulator that can overcome the above-mentioned problems.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure.

FIG. 1 is an isometric view of an electro-optic modulator, according to an embodiment.

FIG. 2 is a cross-sectional view taken along a line II-II of FIG. 1.

### DETAILED DESCRIPTION

Embodiments of the present disclosure will be described with reference to the drawings.

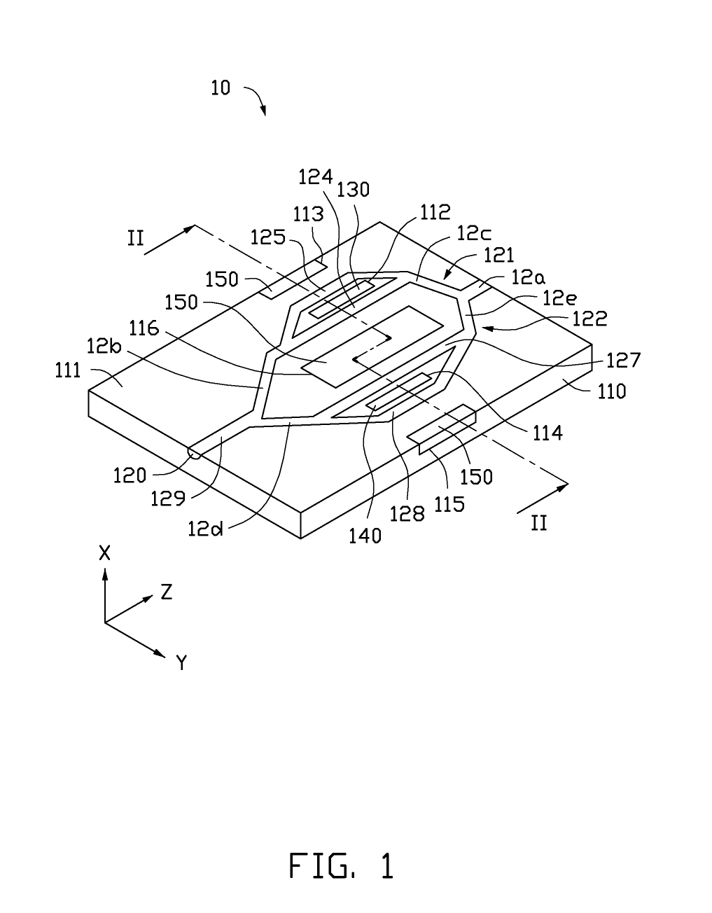

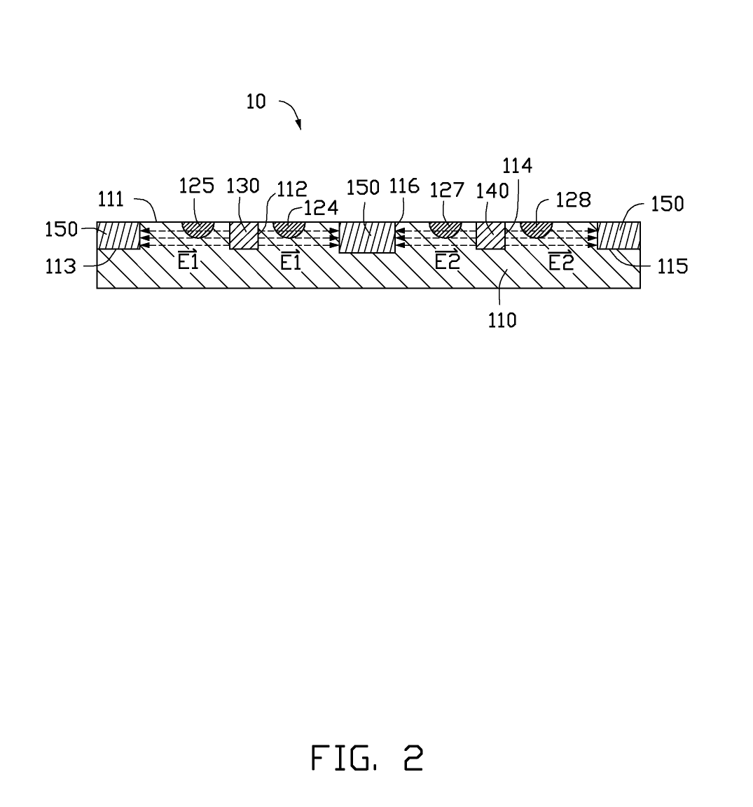

FIGS. 1 and 2 show an electro-optic modulator 10, according to an embodiment. The modulator 10 includes a substrate 110, a waveguide 120, a first modulating electrode 130, a second modulating electrode 140, and three ground electrodes 150.

The substrate 110 is made of lithium niobate (LiNbO₃) crystal to increase a bandwidth of the modulator 10, as LiNbO₃ crystal has a high response speed. In this embodiment, the substrate 110 is substantially rectangular and includes a top surface 111.

The waveguide 120 is formed by applying a layer of titanium as a coating on a shape corresponding to the waveguide 120 and diffusing the titanium into the substrate 110 by, for example, a high temperature diffusion technology. In this embodiment, the waveguide 120 is formed in the top surface 111.

The waveguide 120 is Y-shaped and formed in the substrate 110. The waveguide 120 includes a first section 121 and a second section 122. The first section 121 is Y-shaped and includes a first branch 124 and a second branch 125. The second section 122 is Y-shaped and includes a third branch 127 and a fourth branch 128.

The first to fourth branches 124, 125, 127, 128 are substantially parallel with each other and the second and fourth branches 125, 128 are located at two opposite sides of the first and third branches 124, 127.

In addition to the first section 121 and the second section 122, the waveguide 120 includes an input section 129 and an output section 12a. The first and second sections 121, 122 diverge from the input section 129 and are converged into the output section 12a.

In addition to the first branch 124 and the second branch 122, the first section 121 includes a first input branch 12b and a first output branch 12c. The first and second branches 124, 125 diverge from the first input branch 12b and are converged into the first output branch 12c.

In addition to the third branch 127 and the fourth branch 128, the second section 122 includes a second input branch 12d and a second output branch 12e. The third and fourth branches 127, 128 diverge from the second input branch 12d and are converged into the second output branch 12e.

The substrate 110 defines first to fifth recesses 112-116, all of which are substantially rectangular and arranged to be parallel with the first to fourth branches 124, 125, 127, 128, in the top surface 111. A depth of each of the first to fifth recesses 112-116 is larger than a thickness of the waveguide 120. The first and second recesses 112, 113 are located at two opposite sides of the second branch 125 and have the same length as, and are aligned with, the second branch 125. The first recess 112 is located between the first and second branches 124, 125. The third and fourth recesses 114, 115 are at two opposite sides of the fourth branch 128 and have the same length as, and are aligned with, the fourth branch 128. The third recess 114 is located between the third and fourth branches 127, 128. The fifth recess 116 is located between the first and third branches 124, 127. Orthogonal projections of the first to fourth recesses 112-115 on the fifth recess 116 fall within the fifth recess 116.

The first and second modulating electrodes 130, 140 are fully filled within the first and third recesses 112, 114, respectively. The ground electrodes 150 are fully filled within the second, fourth, and fifth recesses 113, 115, 116.

The first and second modulating electrodes 130, 140 and the ground electrodes 150 receive voltages and modulate the first and second sections 121, 122 such that optical outputs of the first and second sections 121, 122 are equal to each other.

In principle, the output of the output section 12a can be calculated by the following equation:

ae^{i(α-wt)}=a₁e^{i(φ-wt)}+a₂e^{i(β-wt)},

wherein, a, a₁, a₂ are amplitudes of lightwaves traversing the output section 12a, the first output branch 12c, and the second output branch 12e respectively, α, φ, β are phases of lightwaves traversing the output section 12a, the first output branch 12c, and the second output branch 12e respectively, and where e is the natural exponent, i is the imaginary unit, ω is an angular velocity, and t is a time variable.

The output of the output section 12a can be calculated by the following equation:

S=a²=a₁²+a₂²30 2a₁a₂ cos(φ−β),

wherein S is the output of the output section 12a.

Similarly, the outputs of the first and second output branches 12c, 12e can be calculated by the following equations:

a₁e^{i(φ-wt)}=a₁₁e^{i(φ}^{₁}^{-wt)}+a₁₂e^{i(φ}^{₂}^{-wt)},

Q₁=a₁²=a₁₁²+a₁₂²+2a₁₁a₁₂ cos(φ₁−φ₂),

a₂e^{i(φ-wt)}=a₂₁e^{i(β}^{₁}^{-wt)}+a₂₂e^{i(β}^{₂}^{-wt)}, and

Q₂=a₂²=a₂₁²+a₂₂²+2a₂₁a₂₂ cos(β₁−β₂),

wherein a₁₁, a₁₂, a₂₂, a₂₂ are amplitudes of lightwaves traversing the first to fourth branches 124, 125, 127, 128 respectively, φ₁, φ₂, β₁, β₂, are phases of lightwaves traversing the first to fourth branches 124, 125, 127, 128 respectively, and Q₁, Q₂ are the respective outputs of the first and second output branches 12c, 12e.

a₁e^{i(φ-wt)}=a₁₁e^{i(φ}^{₁}^{-wt)}+a₁₂e^{i(φ}^{₂}^{-wt)},

Q₁=a₁²=a₁₁²+a₁₂²+2a₁₁a₁₂ cos(φ₁−φ₂),

a₂e^{i(φ-wt)}=a₂₁e^{i(β}^{₁}^{-wt)}+a₂₂e^{i(β}^{₂}^{-wt)}, and

Q₂=a₂²=a₂₁²+a₂₂²+2a₂₁a₂₂ cos(β₁−β₂),

The lightwaves have transverse electric waves (hereinafter the TE mode) and transverse magnetic waves (hereinafter the TM mode). In a coordinate system xyz (see FIG. 1), wherein x axis is a vertical height of the substrate 110 (i.e., perpendicular to the top surface 111), y axis is a horizontal width of substrate 110 (parallel with the top surface 111 and perpendicular to the first to fourth branches 124, 125, 127, 128), and z axis is a length of the substrate 110 (i.e., along a direction that is parallel with the first to fourth branches 124, 125, 127, 128), the TE mode has an electric field component \vec{Ey} vibrating along the y axis only. The TM mode has an electric field component \vec{Ex} vibrating along the x axis and a \vec{Ez} vibrating along the z axis.

By constructing the first to fifth recesses 112-116, the first and second modulating electrodes 130, 140, and the ground electrodes 150, as described above, modulating electric fields [symbol] 1, [symbol] 2 generated by the first and second modulating electrodes 130, 140 respectively and the corresponding ground electrodes 150 traverse the first to fourth branches 124, 125, 127, 128. A portion of the electric field [symbol] 1 interacting with the first second secondary branches 124, 125 is substantially parallel with the y axis, and thus efficiently modulates the TE mode (i.e. Ey) and alters the phases φ₁, φ₂. Similarly, a portion of the electric field [symbol] 2 interacting with the fourth branch 128 is substantially parallel with the y axis, and thus efficiently modulates the TE mode (i.e. Ey) and alters the phases β₁, β₂.

By changing the phases φ₁, φ₂, β₁, β₂, the equations Q₁=Q₂, and φ−β=0 (or φ−β=π) can be applied. As such, when the modulator 10 is used as a switch, the output of the waveguide 120 can be exactly zero in an off-state and can be substantially at a desired maximum value in an on state, and thus an extinction ratio of the modulator 10 is increased.

It will be understood that the above particular embodiments are shown and described by way of illustration only. The principles and the features of the present disclosure may be employed in various and numerous embodiments thereof without departing from the scope of the disclosure. The above-described embodiments illustrate the possible scope of the disclosure but do not restrict the scope of the disclosure.

What is claimed is:

1. An electro-optic modulator, comprising:
a substrate;
a Y-shaped waveguide formed in the substrate and comprising a first Y-shaped section and a second Y-shaped section, the first Y-shaped section comprising a first branch and a second branch, the second Y-shaped section comprising a third branch and a fourth branch, the second and fourth branches being positioned at two opposite sides of the first and third branches; the substrate defining a first to fifth recesses, the first and second recesses being located at two opposite sides of the second branch, the third and fourth recesses being located at two opposite sides of the fourth branch, the second and fourth recesses being located at two opposite side of the waveguide, the fifth recess being located between the first and third branches;
a first ands second modulating electrodes fully filled in the first and third recesses, respectively; and
three ground electrodes fully filled in the second, fourth, and fifth recesses;
wherein the first and second modulating electrodes and the ground electrodes are configured to receive modulating voltages and modulate the first and second sections such that outputs of the first and second sections are equal to each other.

2. The modulator of claim 1, wherein the substrate is made of lithium niobate crystal.

3. The modulator of claim 1, wherein the waveguide is made of lithium niobate crystal diffused with titanium.

4. The modulator of claim 1, wherein the waveguide comprises an input section and an output section, and the first and second sections diverge from the input section and are converged into the output section.

5. The modulator of claim 1, wherein the first section comprises a first input branch and a first output branch, and the first and second branches diverge from the first input branch and are converged into the first output branch.

6. The modulator of claim 1, wherein the second section comprises a second input branch and a second output branch, and the third and fourth branches diverge from the second input branch and are converged into the second output branch.

7. The modulator of claim 1, wherein the first to fourth secondary branches are parallel with each other.

8. The modulator of claim 7, wherein the first to fifth recesses are rectangular and parallel with the first to fourth branches.

9. The modulator of claim 8, wherein the first and second recesses have the same length as and are aligned with the second branch.

10. The modulator of claim 8, wherein the third and fourth recesses have the same length as and are aligned with the fourth branch.

11. The modulator of claim 8, wherein orthogonal projections of the first to fourth recesses on the fifth recess fall within the fifth recess.
